(19) United States
(12) Patent Application Publication
(10) Pub. No.: US 2010/0060583 A1
(43) Pub. Date: Mar. 11, 2010

(54) Input devices operable by reflected light

(76) Inventor: Yong Yan, Sunnyvale, CA (US)

Correspondence Address: Yong Yan, 950 Eton Way, Sunnyvale, CA, 94087, US

(21) Appl. No.: 12/204,828

(22) Filed: Sep. 5, 2008

(51) Int. Cl. G06F 3/033; G06F 3/00; G06F 3/02

(52) U.S. Cl. 345/166; 345/156; 345/168; 345/157

(57) ABSTRACT

An optical input apparatus including light sources, light receiving areas, and processing circuits. The light from the sources can be reflected by fingers into the receiving areas where the incident light can trigger electrical signals. The processing circuits can process the signals and transmit corresponding data entry or pointing information to host computer or other electronic systems.

The light receiving areas can be arranged and assigned functions to perform keyboard and mouse functions. Additional touch/pressure-triggered switch can be included to assist selection of keys. This invention enables fast and touchless operation of keyboard and mouse that avoid repetitive strain injuries and pains. It also enables fast and more convenient use of small size keyboard.

### BACKGROUND OF THE INVENTION

1. Field of the Invention

This invention relates to input devices such as keyboard and pointing devices to computers and other electronic systems such as phones and game machines that use keypad or pointing devices. More specifically, this invention relates to the keypads and pointing devices that can be operated by reflected light.

2. Description of the Related Art

Any discussion of the prior art throughout the specification should in no way be considered as an admission that such prior art is widely known or forms part of common general knowledge in the field.

There have been various attempts to use a beam of light to operate keyboard and pointing devices for computers. U.S. Pat. No. 3,761,877 discloses an optical graphic data tablet operated with a light pen. The position of the light spot on the plate indicated by a digital position indicator determines the signal to be sent to the computer. But its embodiments require the use of optical filters to shield the background light, and it is necessary either to maintain the intensity of light as received at the photocell at a constant level by means of a feedback circuit or correct for variations in light intensity. These requirements made the implementation expensive and difficult to build in the consumer market place. The light spot needs to be much brighter than the background or oscillating in itself, which are harmful for the eyes to look at for an extended period of time. Besides, no mechanisms similar to mouse operations such as selection and clicking was disclosed.

U.S. Pat. No. 4,713,535 discloses an optical keyboard which comprises an array of photo sensors that are arranged in an X-Y coordinate system. When a beam of light is cast onto a photo sensor, the photo sensor is actuated to transmit a coded signal to a microprocessor board, which then send a converted data to the computer. This design would significantly slow down the input speed as when the light beam moves from one sensor to another, special care and path need to be taken to avoid the sensors in between. Besides, the signal received is compared with a reference signal to check for validity, which means the intensity of the light beam needs to be significantly above the background light and may be harmful for the eyes to look at for an extended period of time.

U.S. Pat. No. 5,883,616, and U.S. Pat. No. 6,097,373 all disclosed computer input devices operated by a light beam for disabled people who can not operate manually a regular computer. The light sources in these inventions are all designed to be worn on the user's head. They all require an independent switching mechanism that can be used to select the desired sensor being illuminated.

My invention, U.S. Pat. No. 6,770,864, revealed a method of using a hand-held light beam to enter keyboard signals and control cursor movement on a display. The purpose of the endeavor is to develop a new but still manual operation method that can be a feasible alternative for today's keyboard and mouse, but with minimal or no injury effects on user's hands and bodies. In the process of reduction to practice, some issues were found to be expensive and inconvenient for the users: The light beam in the patent was chosen to be narrow and directional. However, to use any visible light, the light spot on the receiver box needs to be significantly brighter than the background light for the sensors to distinguish the two. It can be tiring for the eyes to look at the bright spot for a long time. When the background light is very bright, it's difficult for the light sensors to work well.

Another drawback of U.S. Pat. No. 6,770,864 is that it does not disclose methods for avoiding accidental “hits” on the keyboard entries that may trigger unintended signals to the computer. These undesired hits can be caused by accidental random light or the moving light beam, particularly when the light beam is moving fast.

All the inventions mentioned above and found in the searches that try to use light beams to operate input devices have one feature in common, i.e. the user needs to hold and move a source of light. This movable light source not only adds burden to the user, but also limits the speed of data entry as there has to be a movement of the light source.

### BRIEF SUMMARY OF THE INVENTION

The present invention includes specially arranged light sources, a receiver box that contains sensors for detecting light of the same wave length as that from the sources, a circuit inside the receiver box to process and transmit the signals to a connected digital processor. The light source or sources are arranged in such a way that enough photons from the source can be easily reflected by a finger or other reflective surfaces such as that of a plastic pen into the sensors and trigger some signals.

A primary object of the present invention is to enable light operated input devices to work without the need for the user to bear the weight of the light emitting devices, and thus reduce the factors of strain and fatigue from holding and moving a solid object for the user. Another object is to enable the uses of multiple fingers to increase the speed of data input. Yet another object is to enable the device to work well in various background lighting conditions without harmful effects on the eyes. Yet another object is to avoid forces on hands but enable fast and easy data input. Some arrangements of the light sources, sensor areas, and special operation mechanisms are also introduced to facilitate fast and easy usage of such devices.

### BRIEF DESCRIPTION OF THE DRAWINGS

In the drawings, closely related objects have the same number but different letters.

FIG. 1 is a simplified diagram of the components and structure of a basic system.

FIG. 2 shows another arrangement of the light source of a basic system.

FIG. 3 shows an arrangement of a special light sensitive area for stopping the cursor movement.

FIG. 4 shows another arrangement of the light sensitive areas for stopping the cursor movement.

FIG. 5 shows some small and closely arranged light sensitive areas that using an additional pressure-triggered switch to confirm a selection.

FIG. 6 shows some small and closely arranged light sensitive areas that using an additional touch-triggered switch to confirm a selection.

FIG. 7 shows how reflective light switches can be used for mouse buttons.

FIG. 8 shows how reflective light switches can be used for the mouse scrolling wheel.

### DETAILED DESCRIPTION OF THE INVENTION

The purpose of this invention is to solve some problems that occurred in the process of reducing my invention of U.S. Pat. No. 6,770,864 to practice, and to improve the reliability, speed of data entry, and ease of use.

In general, when a reflector is approaching close to a sensor area and recognized by the system, a signal of keyboard or mouse button depressed or cursor movement is sent to the computer. When the reflector raises up or move out of the sensor area to stop the triggering, a button released or cursor movement stop signal is sent to the computer.

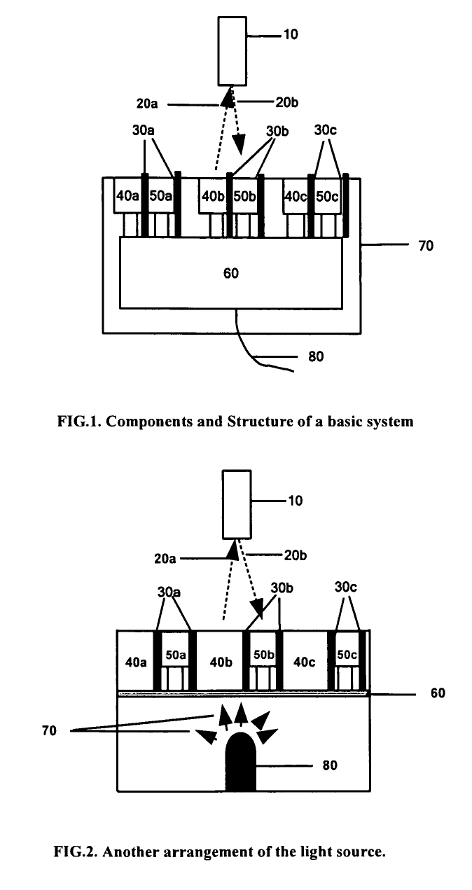

FIG. 1 shows the essential components and structure of an input device operated by reflected light. Item 10 is a finger or pen style stick with a reflective surface that can reflects light emitted from the device. Item 20a is the light coming out of the device and item 20b is the light being reflected by item 10.

Items 30a, 30b, and 30c are optical isolating tubes inside which optical sensors 50a, 50b, 50c are protected from the light coming from sides. LEDs 40a, 40b, 40c emit light to be reflected to activate the sensors. While the wave length of the light can work in a wide range, it is found that Infrared light works better than visible light for optical stability and the ease on the eyes.

These light emitters and sensors are connected to a circuit 60 that includes a microprocessor, in this case a microcontroller to process the signals received. Item 70 is a frame or enclosure to contain all the circuits. Item 80 indicates a wire connection to any external entities.

FIG. 2 illustrates a different embodiment of the light source. Here, item 80 is a LED and 70 is the light rays emitted. Item 60 is an optional translucent plate to make the light more homogeneous and isotropic. Holes 40a, 40b, 40c let the light coming out to form light sources around the sensors. Items 50a, 50b, 50c are photon-sensors that are protected by optical isolating tubes 30a, 30b, 30c from side light. 20a and 20b are the emitting and reflected light rays. Item 10 is the reflector, finger or pen.

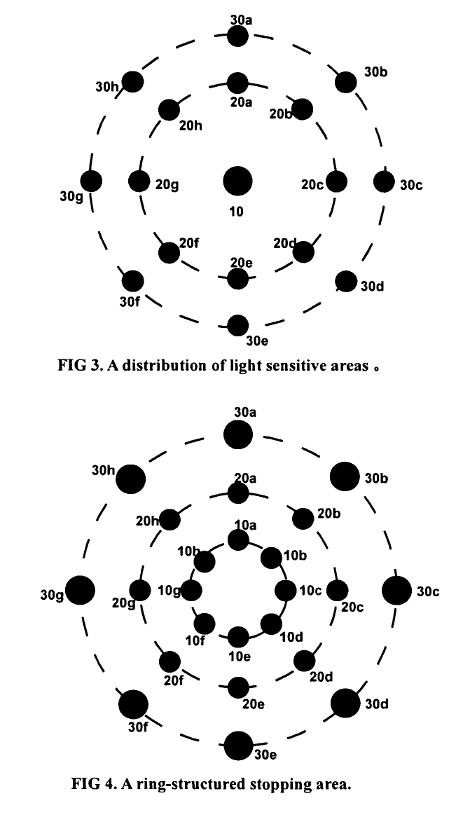

FIG. 3 shows an example layout of light sensitive areas for moving the cursor on screen. Item 10 is a light sensitive area that when it is hit, the cursor stops moving. In my invention of U.S. Pat. No. 6,770,864, the cursor stops moving when the sensors are no longer hit by the light beam. However, it takes some time to move the light out and makes it difficult to stop the cursor exactly at a desired location. A light sensitive area dedicated to stopping the cursor movement enables precision control of the cursor movement.

Items 20a-20h are light sensitive areas of the inner ring. When these areas are triggered by reflected lights, the cursor will move in the direction from the center to the lit area. Items 30a-30h are also light sensitive areas and functions similarly to that of 20a-20h. However, the speed of the cursor can be determined when the reflector moves across different light sensitive areas.

FIG. 4 shows another layout of light sensitive areas. Items 10a-10h, and 20a-20h are light sensitive areas that when hit will cause the cursor to move. On the other hand, 30a-30h are light sensitive areas that when hit, will stop the movement of the cursor.

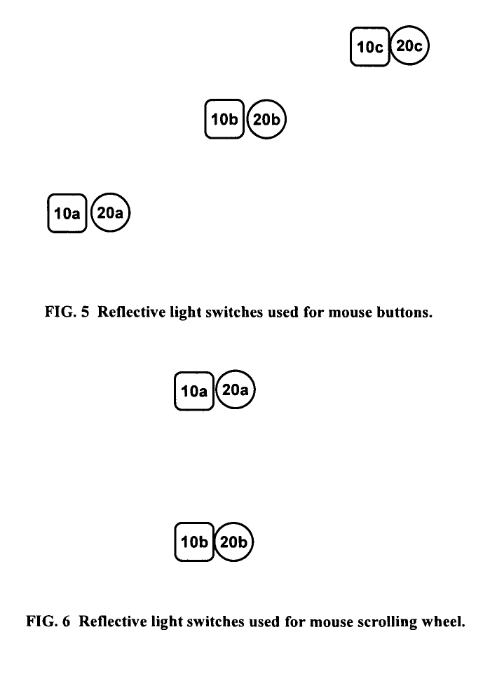

In FIG. 5. light emitters and sensors are coupled together to function as mouse buttons. Items 10a, 10b, and 10c are light sensitive areas and items 20a, 20b, 20c are light outlets. When a finger or reflector is placed above one of the sensors, the light from the neighboring outlet is reflected into the sensor and triggers a button-pushed signal. When the light stops entering the sensor, a button-released signal is recognized.

In FIG. 6. light emitters and sensors are coupled together to function as mouse scrolling wheel. Items 10a and 10b are light sensors. Items 20a and 20b are light emitters respectively. When 10a is triggered, a scrolling-up signal is generated. When 10b is triggered, a scrolling-down signal is generated.

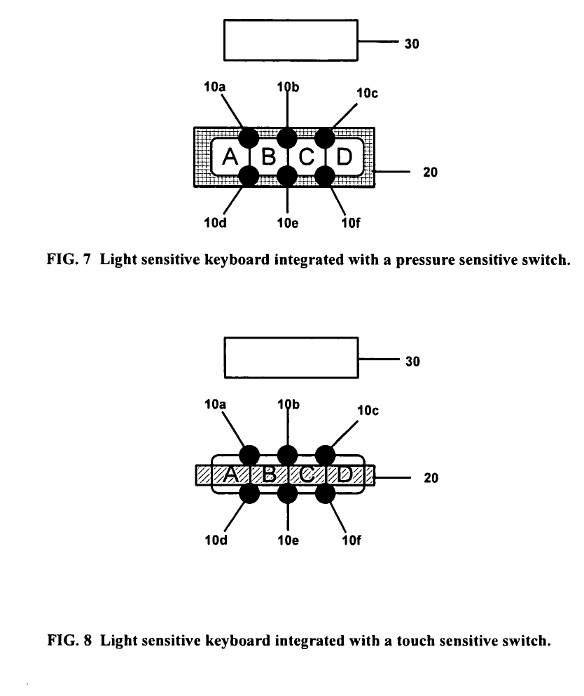

In FIG. 7, the light triggered keyboard is integrated with a pressure triggered switch for small size entry panels such as those on cell phones and PDAs. Items A-D are light sensitive areas used for keys on a keypad. Items 10a-10f are light outlets from which the light comes out and can be reflected to trigger the keys. The keys and light outlets are so small that a finger may trigger more than one key entries. In such situations, the symbol of one of the triggered keys is displayed in the screen 30. When the desired key is displayed in the screen, pressure triggered switch 20 can be pressed to confirm the selection.

FIG. 8. illustrates a similar setup as in FIG. 7 but with the pressure-switch replaced by a touch-switch 20. Here again items A-D are light sensitive areas used for keys on a keypad. Items 10a-10f are light outlets from which the light comes out and can be reflected to trigger the keys. The keys and light outlets are so small that a finger may trigger more than one key entries. In such situations, the symbol of one of the triggered keys is displayed in the screen 30. When the desired key is displayed in the screen, a change of the state of touch switch 20 is used to confirm the selection. In some cases, such a touch-switch may not be needed as taking the finger off the reflective area can signal the selection.

### Advantages

From the description above, a number of advantages of some embodiments of the input devices operable by reflected light revealed here become evident:

(1) The user no longer has to hold the light source in the hand or bear it with the body, and thus lead to less effort, less strain, and less tiring in the operation of the device.

(2) Multiple fingers or reflectors can be utilized for data entry and the speed is improved.

(3) Using Infrared emitters and sensors improves the optical stability.

(4) Using optical isolating tubes to improve the optical stability of the device.

(5) Dedicated light sensors for stopping the movement of the cursor improves usability.

(6) The integration of reflective optical keys with a display and other switches enables very small size input panels.

(7) Using light sensor triggering to function as mouse buttons and scrolling wheel avoids the use of finger touching the mouse, which further reduces the harmful effects on the fingers.

### Conclusion, Ramification, and Scope

From the above description, the reader can see that this optical input interface can be reliable, fast, easy to use.

While the above description contains much specificity, these should not be construed as limitations on the scope of the invention, but rather as exemplifications of several preferred embodiments thereof. Many other variations are possible. For example, the light sensors can be arranged in a matrix form and using the speed of the movement of the reflector to determine the movement of the cursor.

The spirit of the present invention provides a breadth of scope that includes all methods of using reflected light to operate keyboards and pointing devices reliably, fast, and easily so that the general public can use to avoid repetitive strain injuries and related pains. Any variation on the theme and methodology of accomplishing the same that are not described therein would be considered under the scope of the present invention.

I claim:

1. An input apparatus to computers and other electronic systems, comprising: (a) distributed light sensitive areas that will generate electrical signals upon local light incident of certain wave lengths; (c) light emitting areas from which said light can be reflected by a reflector of a finger or pen style stick into said light sensitive areas and generate said signals.(b) circuits that processes said signals and transmit data entry or pointing information to said host computers or electronic systems;

2. The apparatus of claim 1 wherein each said light sensitive area represents a key of a keyboard, when said reflector generates triggering signals, a key depressed signal is sent to said computer or systems, when said reflector stops generating triggering signals, a key released signal is sent to said computer or systems.

3. The apparatus of claim 1 wherein the position and movement of the reflector determine the direction and speed of a cursor on a display of said computer.

4. The apparatus of claim 1 wherein there are one or more specific said light sensitive areas that when triggered, will stop the the movement of the cursor on a display.

5. The apparatus of claim 1 wherein there one or more specific said light sensitive areas that when triggered, will send signals of mouse button clicks to said host computer.

6. The apparatus of claim 1 wherein there are one or more specific said light sensitive areas that when triggered, will send signals of scrolling wheel movement of a mouse to said host computer.

7. The apparatus of claim 1 with a display area such that a symbol representing one of the said triggered light sensitive areas can be displayed in said display area.

8. The apparatus of claim 7 such that the ending of said reflective triggering signals a selection of said displayed symbols.

9. The apparatus of claim 7 with an additional switch, including touch-triggered style, push-triggered style, optical style switches and etc. to confirm a selection of said displayed symbols.

10. A method for entering information into a computer and other electronic systems, comprising the means of: (a) providing distributed light sensitive areas that will generate electrical signals upon local light incident of certain wave lengths; (b) providing light of said wave length that can be reflected by a reflector of a finger or other pen style stick into said light sensitive areas to generate said signals; (c) providing circuits that process said signals, and transmit corresponding data entry or pointing information to said host computer or other electronic systems.

11. The method of claim 10 wherein a means is provided to send key-depressed signals to said computer and other systems when said reflector is generating triggering signals, and to send key-released signals to said computer and other systems when said reflector stops generating triggering signals.

12. The method of claim 10 wherein a means is provided to determine the direction and speed of the cursor movement on a display of said computer.

13. The method of claim 10 wherein a means is provided with one or more specific said light sensitive areas that when triggered, will stop the the movement of the cursor on a display.

14. The method of claim 10 wherein a means is provided with specific said light sensitive areas that when triggered, will send signals of mouse button clicks to said host computer.

15. The method of claim 10 wherein a means is provided with specific said photon sensitive areas that when triggered, will send signals of scrolling wheel movement of a mouse to said host computer.

16. The method of claim 10 with means to provide a display area such that a symbol representing one of the said triggered light sensitive areas can be shown in said display area.

17. The method of claim 16 with a means to end said triggering process selects the said displayed symbol as desired.

18. The method of claim 16 with means to provide a switch (including touch-triggered style, push-triggered style, optical style, and etc.) to signal a selection of said displayed symbol.
